(19) United States
(12) Patent Application Publication
(10) Pub. No.: US 2020/0063326 A1
(43) Pub. Date: Feb. 27, 2020

(54) WASHING MACHINE HAVING IMPROVED MAINTENANCE FEATURES

(71) Applicant: Daewoo Electronics Co., Ltd., Gwangju (KR)

(72) Inventor: Hye-Ung KIM, Bupyeong-gu (KR)

(21) Appl. No.: 16/255,083

(22) Filed: Jan. 23, 2019

(30) Foreign Application Priority Data
Aug. 22, 2018 (KR) 10-2018- 0097968

(51) Int. Cl. D06F 39/08; D06F 23/04; B08B 9/08

(52) U.S. Cl. CPC D06F 39/083; B08B 9/0817; D06F 23/04

(57) ABSTRACT

The present invention generally relates to a washing machine. More particularly, the present invention relates to a washing machine, wherein an inner wall of a water tank (20) is visible from an inner space of a washing tub (30) so a user can easily remove foreign materials such as slime accumulated on the inner wall of the water tank (20) and visibly check whether the foreign materials are removed. The washing machine having: a casing part; a water tank for storing washing water and having a washing tub, the washing tub for receiving washing items stored therein and being rotated by a driving means; and at least one discharge member including at least one discharge opening for discharging circulating washing water to an inner space of the washing tub, wherein the washing tub includes a first observing element provided thereon, the first observing element allowing the washing tub to communicate with the water tank when an inner wall of the washing tub with which the discharge member is combined is opened.

### CROSS REFERENCE TO RELATED APPLICATION

The present application claims priority to Korean Patent Application No. 10-2018-0097968, filed Aug. 22, 2018, the entire contents of which is incorporated herein for all purposes by this reference.

### BACKGROUND OF THE INVENTION

### Field of the Invention

The present invention generally relates to a washing machine. More particularly, the embodiments of the present invention relate to a washing machine having improved maintenance features.

### Description of the Related Art

Generally, a washing machine is mechanical appliance for washing items such as clothes, etc., using electric power, and includes a water tank 910 for storing washing water and a rotating tub 930 provided in the water tank and rotated by a drive motor 970. In addition, the rotating tub 930 includes at least one guide filter 950 arranged on an inner wall of the rotating tub 930 to supply washing water to items positioned on an inner side of the washing machine (see FIG. 1).

Generally, when the washing machine 900 as shown FIG. 1 is used over time, foreign materials such as slime, etc., and other material, are accumulated on an inner wall of the water tank 910. Accordingly, the inner side of the water tank 910 requires regular cleaning to remove this built-up material. As for the conventional washing machine 900, in the process of washing, various problems can occur, and a detailed description thereof is presented below.

First, to clean the inner side of the water tank 910, the rotating tub 930 needs to be completely disassembled from the water tank 910, which disassembly must be performed by skilled workers. Accordingly, the method of cleaning the water tank 910 by disassembling the washing machine enables thorough cleaning, but the method is complex and requires additional consumer expense.

Furthermore, although cleaning may be performed by using a cleaning solution, it is not possible for a user to visualize the inner wall of the water tank 910 and thus the user cannot determine if the cleaning removed all the built-up material as described above.

To solve the above-mentioned problems, the present invention describes a washing machine, wherein it is possible to enable easy cleaning of the inner wall of the water tank and to determine whether the appliance is completely clean of the above described built-up material.

### SUMMARY OF THE INVENTION

Accordingly, embodiments of the present invention include a washing machine, wherein a first observing element is provided to open an inner wall of a washing tub with which a discharge member supplying washing water is combined, so that a user can observe an inner wall of a water tank from an inner space of the washing tub. This configuration enables easy removal of foreign materials, such as slime, etc., accumulated on the inner wall of the water tank, and enables a visual inspection by the user of whether or not the cleaning process completely removed the foreign accumulated materials from the inner wall.

Furthermore, embodiments of the present invention include a washing machine, wherein a first observing element is used to enable cleaning an inner wall of the water tank to eliminate the need to completely disassemble the washing machine in order to clean the inner wall and also to thereby reduce expenses associated with the cleaning process.

In addition, embodiments of the present invention include a washing machine, wherein a discharge member positioned on a front side of a first observing element is coupled to or decoupled from an inner wall of the water tank to promote the efficient circulation of washing water during cleaning and to enable the inner wall of the water tank to be observed according to user need during the cleaning process and for visually determining when a cleaning may be required.

Additionally, embodiments of the present invention include a washing machine, wherein a coupling plate constitutes a part of a rear surface of a filter guide member and is removably combined with the filter guide member such that filtered washing water supplied into an inner space of the water tank is not prevented from forming a flow path.

Furthermore, embodiments of the present invention include a washing machine, wherein while unfiltered washing water (including foreign materials) is supplied to the washing machine, filtered washing water is supplied to an inner space of the washing tub in order to promote easy circulation of the washing water.

In order to achieve the above objects, embodiments having the following configuration are provided.

According to an embodiment of the present invention, there is provided a washing machine including: a casing part constituting an outer wall of the washing machine and protecting components therein; a water tank for storing washing water and having a washing tub positioned in space defined by an inner wall of the water tank; the washing tub for receiving washing items stored therein and operable to be rotated by a driving means coupled to one side of the washing tub; and at least one discharge member including at least one discharge opening disposed on a front surface thereof and operable to discharge circulating washing water to an inner space of the washing tub, wherein the washing tub comprises a first observing element provided thereon, the first observing element allowing the washing tub to communicate with the water tank when an inner wall of the washing tub, with which the discharge member is combined, is opened.

According to another embodiment of the present invention, the discharge member disposed of the washing machine may be removably combined with the inner wall of the washing tub, and wherein the first observing element is configured with a shape that is complementary to a shape of a rear surface of the discharge member.

According to still another embodiment of the present invention, the discharge member provided in the washing machine may supply washing water circulating through a flow path thereof via the discharge openings provided on the front surface of the discharge member to the inner space of the washing tub and includes a water supply member that covers the first observing element that is provided on the washing tub.

According to still another embodiment of the present invention, the washing tub provided in the washing machine may further include through holes provided on sides neighboring the first observing element, wherein the through holes are formed through the inner wall of the washing tub, and wherein further the water supply member may include coupling pins disposed on a rear surface thereof and protruding therefrom, wherein the coupling pins extend in horizontal directions from the rear surface of the water supply member and are bent downward for insertion into, and for combination with, the through holes.

According to still another embodiment of the present invention, the washing machine may include a recessed part provided on one side thereof, the recessed part being recessed at a predetermined depth from a front surface thereof to a rear surface thereof and may further include a filter guide member adjacent to edges of the first observing element, and wherein the discharge member may be disposed in an inner space of the recessed part by being inserted thereinto and may include a frame member operable to discharge circulating washing water to the inner space of the washing tub.

According to still another embodiment of the present invention, the filter guide member may further include a coupling plate disposed on a rear surface thereof, the coupling plate being removably combined on the rear surface of the filter guide member to cover the first observing element.

According to still another embodiment of the present invention, the coupling plate may include a first combination pin, the first combination pin disposed on an upper surface thereof such that the first combination pin fixes an upper side of the coupling plate to the inner wall of the washing tub wherein the first combination pin is fixed by being inserted into an insertion hole provided on the inner wall of the washing tub.

According to still another embodiment of the present invention, the frame member may include a case member disposed on a front surface thereof, the case member operable to supply washing water via the discharge openings disposed on one side of the case member to an inner space of the washing tub; a filter part of a mesh structure arranged on a rear surface of the case member and operable to filter foreign materials included in the washing water; and a flow path forming member combined on a rear side of the case member, the flow path forming member having a first flow path defined in cooperation with the inner wall of the case member and having a second flow path defined as being spaced apart from the filter guide member.

According to still another embodiment of the present invention, height of the flow path forming member may be lower than height of the case member.

According to still another embodiment of the present invention, the filter guide member may further include a combining step element provided on an upper side of the recessed part and protruding therefrom to a center of the washing tub in a horizontal direction, and wherein the case member includes a combining part disposed on an upper surface thereof, the combining part being allowed to flex in thickness to come into close contact with the combining step element, wherein the combining part may have a bent part in a U shape and disposed on the upper surface of the case member, wherein the bent part is pressed in an upper side thereof by a lower surface of the combining step element, and a protruding part being in contact with a front surface of the step element by extending from the upper side of the bent part in a protruding direction from the protruding part.

According to still another embodiment of the present invention, the first observing element may be configured to be within a range of 50 mm to 90 mm in horizontal length and within a range of 500 mm to 700 mm in vertical length, and wherein the discharge member may be longer than the first observing element corresponding thereto in vertical length and horizontal length to cover the first observing element in such fashion that the first observing element can be covered or uncovered.

According to still another embodiment of the present invention, the recessed part may be longer than the first observing element in vertical length and horizontal length, wherein the first observing element may be configured to be within a range from 50 mm to 90 mm in horizontal length and within the range of 500 mm to 700 mm in vertical length, and the recessed part may be configured to be within a range of 80 mm to 100 mm in horizontal length and within a range of 700 mm to 800 mm in vertical length.

According to still another embodiment of the present invention, the coupling plate may have a shape complementary to a shape of the first observing element and may be configured to have the same size as a size of the first observing element.

According to still another embodiment of the present invention, there is provided a washing machine including: a casing part constituting an outer wall of the washing machine and protecting components therein; a water tank operable to store washing water and having a washing tub positioned in space defined by an inner wall of the water tank; the washing tub operable to have washing items stored therein and operable to rotate under control of a driving means connected to a lower part of the washing tub; a frame member being arranged in an inner space of a filter guide and being inserted thereinto and operable to discharge circulating washing water via discharge openings provided on one side of the frame member to an inner space of the washing tub; and a filter guide member arranged on one side of an inner wall of the washing tub, the filter guide member including a recessed part that is recessed in a predetermined depth from a front surface thereof to a rear surface thereof and being open on a part of a rear surface thereof, wherein the washing tub includes a first observing element disposed thereon, the first observing element allowing the washing tub to communicate with the water tank when an inner wall of the washing tub is opened, the inner wall of the washing tub being combined with a case member.

According to still another embodiment of the present invention, the filter guide member may include a coupling plate provided on an open rear surface of the filter guide member, the coupling plate being removably combined with the filter guide member to cover the first observing element.

According to still another embodiment of the present invention, the coupling plate may include a first combination pin and a second combination pin disposed on an upper surface thereof and a lower surface thereof respectively wherein the first combination pin and the second combination pin fix an upper side of the coupling plate and a lower side thereof respectively to the inner wall of the washing tub by being inserted into insertion holes provided on the inner wall of the washing tub.

According to still another embodiment of the present invention, the filter guide member may be adjacent to edges of the first observing element or to cover a part of the first observing element.

According to still another embodiment of the present invention, the frame member may include a filter part arranged on the discharge openings of the case member so as to filter foreign materials included in washing water.

According to still another embodiment of the present invention, the frame member may further include a flow path forming member combined on a rear side of the case member at a rear side of the filter part, wherein the flow path forming member has a first flow path defined in cooperation with the inner wall of the case member and the flow path forming member having a second flow path defined by being spaced apart from the filter guide member.

According to still another embodiment of the present invention, the washing machine of the present invention may further include: a case member arranged on a position corresponding to a position of a second observing element provided on the water tank and to cover an open space defined by the second observing element, wherein the case member may include the discharge openings provided on a front surface thereof for supplying circulating washing water to the inner space of the washing tub.

The present invention has the following effects due to the configuration mentioned above.

According to the embodiments of the present invention, the washing machine includes the first observing element to allow an inner wall of the washing tub (with which a discharge member supplying washing water is combined) to be open, therefore allowing a user to visualize an inner wall of the water tank from an inner space of the washing tub. This configuration enables easy removal of foreign materials, such slime, etc., and other material accumulated on the inner wall of the water tank and visual checking and determination of whether or not the foreign materials are completely removed thereafter from the inner wall.

Furthermore, according to the embodiments of the present invention, the washing machine uses the first observing element to make an inner wall of the water tank visible during cleaning thereof, thereby eliminating any need to disassemble the washing machine for cleaning and thereby reducing cleaning costs and complexity.

In addition, according to the embodiments of the present invention, the washing machine includes the discharge member positioned on a front side of the first observing element in such a manner that the discharge member can be coupled to, or decoupled from, an inner wall of the water tank, thereby promoting the efficient circulation of washing water during cleaning and also enabling the inner wall of the water tank to be readily observed as needed.

Additionally, according to the embodiments of the present invention, the washing machine includes the coupling plate constituting a part of a rear surface of the filter guide member and being removably combined with the filter guide member, thereby facilitating forming flow paths of washing water supplied into an inner space of the washing tub after being filtered.

Furthermore, according to the embodiments of the present invention, the washing machine supplies filtered washing water to an inner space of the washing tub while supplying unfiltered washing water, including foreign materials, to the washing machine, thereby promoting easy circulation of washing water.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a cross-sectional view showing some parts of a conventional washing machine;

FIG. 2 is a partial perspective view showing a washing tub viewed from a first direction according to an embodiment of the present invention;

FIG. 3 is an exploded perspective view of FIG. 2;

FIG. 4 is a partial perspective view showing a washing tub viewed from a second direction according to an embodiment of the present invention;

FIG. 5 is an exploded perspective view of FIG. 4;

FIG. 6 is an exploded perspective view of a frame member according to FIG. 4;

FIG. 7 is a side cross-sectional view of the frame member according to FIG. 4; and

FIG. 8 is a view showing the state of a first observing element opened by the frame member and a coupling plate being removed from an inner wall of the washing tub according to an embodiment of the present invention.

### DETAILED DESCRIPTION OF THE INVENTION

Hereinbelow, exemplary embodiments of the present invention will be described in detail with reference to the accompanying drawings. The embodiments of the present invention may be modified variously, and the scope of the present invention should not interpreted as being limited to the embodiments presented below but with reference to the scope of the claims. In addition, the embodiments of the present invention are presented as a reference to describe fully the present invention to those skilled in the art.

Hereinafter, according to the embodiments of the present invention, a washing machine having improved maintenance features will be described in detail referring to the accompanying drawings.

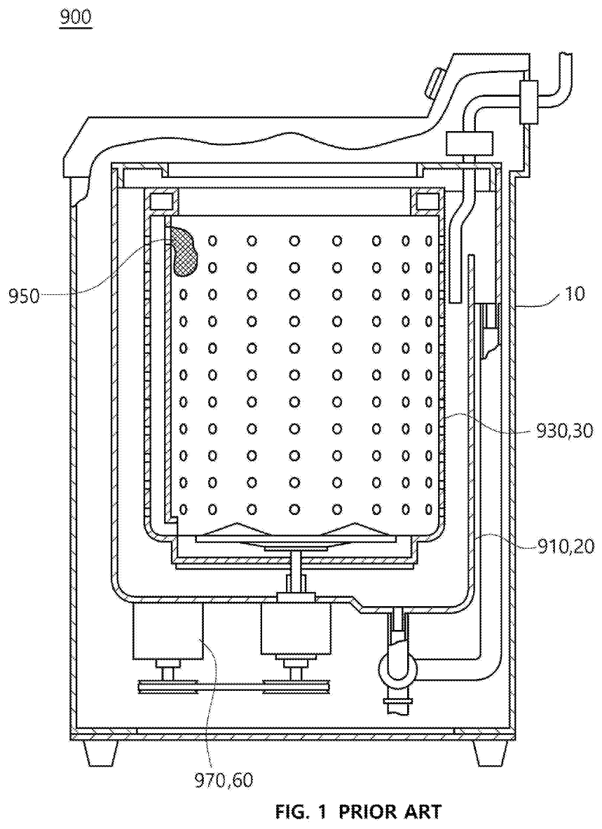

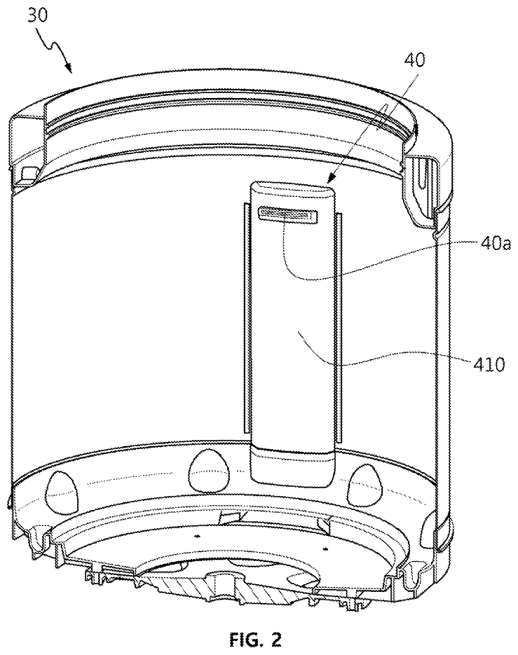

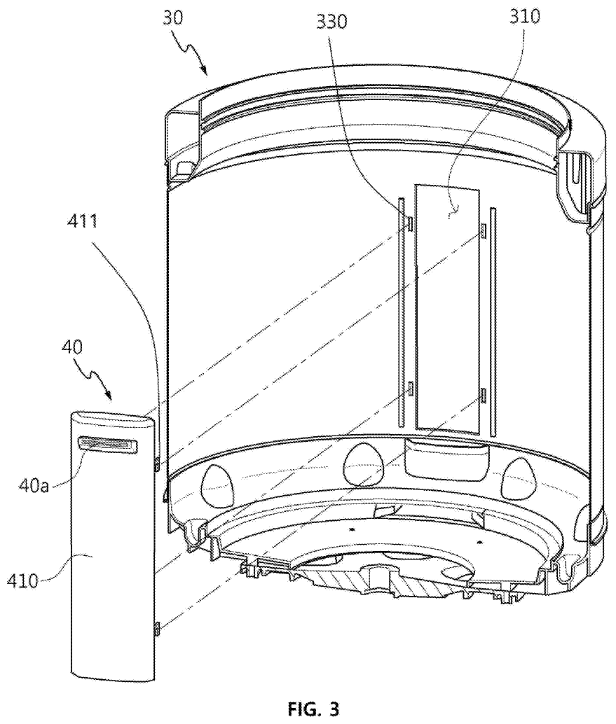

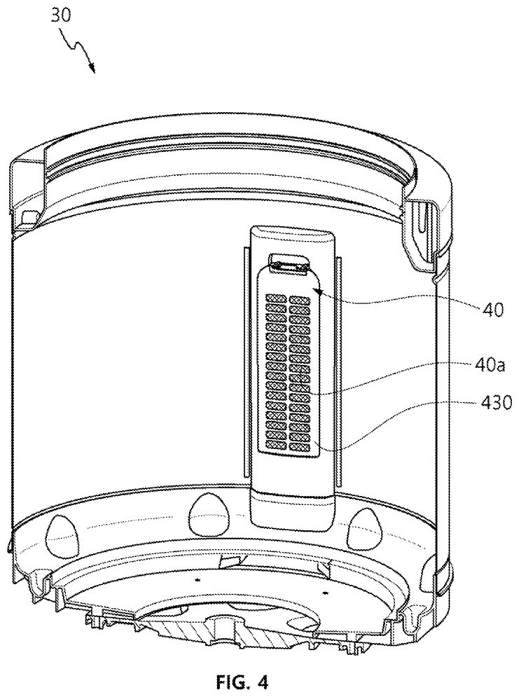

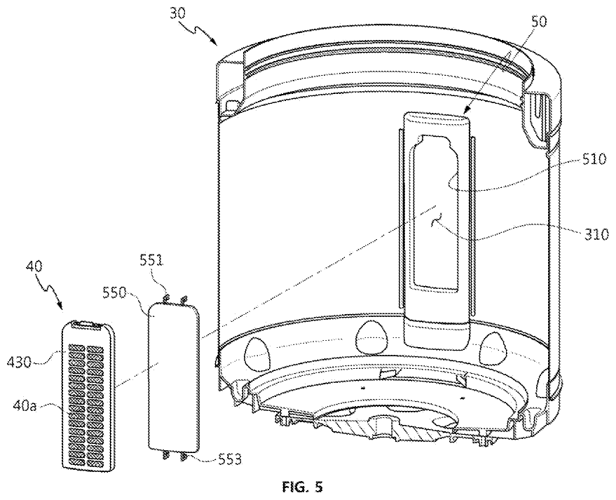

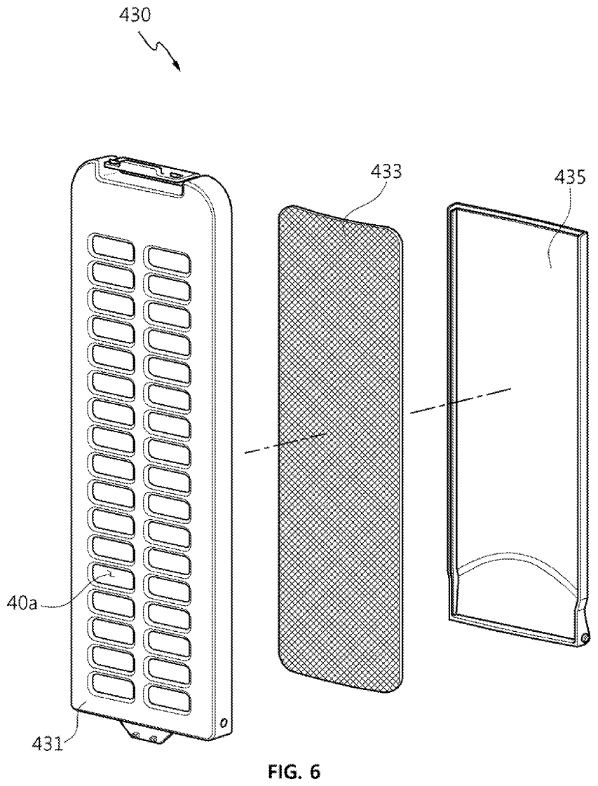

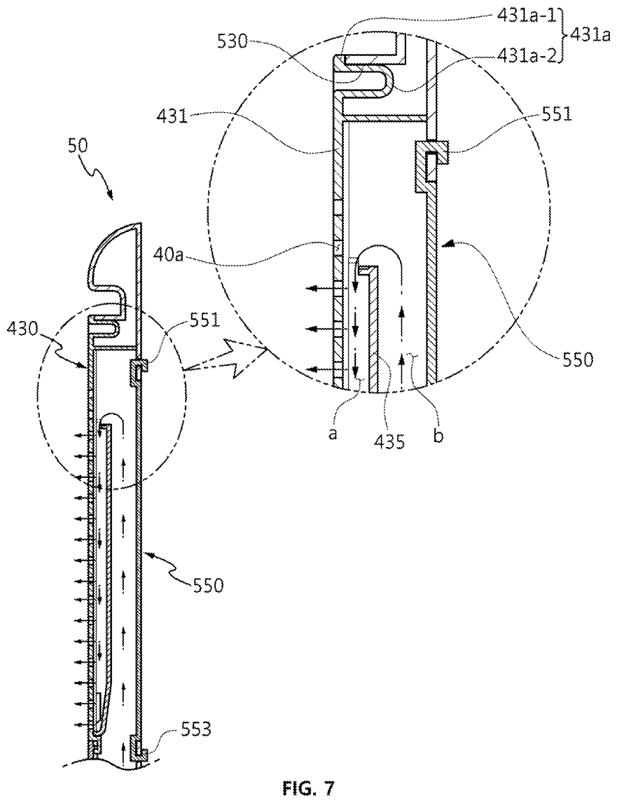

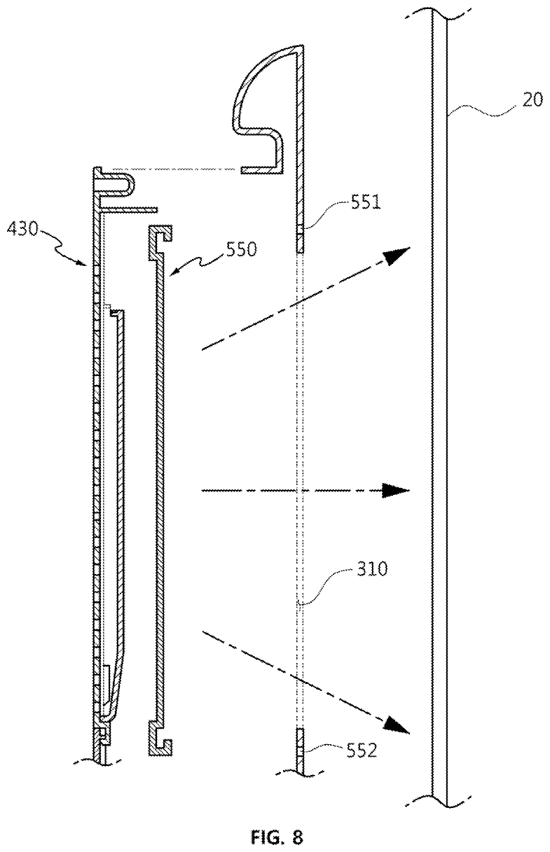

FIG. 1 is a cross-sectional view showing components of a conventional washing machine; FIG. 2 is a partial perspective view showing a washing tub viewed in a first direction according to an embodiment of the present invention; FIG. 3 is an exploded perspective view of FIG. 2; FIG. 4 is a partial perspective view showing the washing tub viewed in a second direction according to an embodiment of the present invention; FIG. 5 is an exploded perspective view of FIG. 4; FIG. 6 is an exploded perspective view of a frame member according to FIG. 4; FIG. 7 is a side cross-sectional view of the frame member according to FIG. 4; and FIG. 8 is a view showing the state of a first observing element opened by the frame member and a coupling plate being removed from an inner wall of the washing tub according to an embodiment of the present invention.

Referring to FIG. 1, FIG. 3, and FIG. 5, the embodiments of the present invention generally relate to a washing machine. More particularly, the embodiments of the present invention relate to a washing machine, wherein a user is allowed to visualize an inner wall of a water tank 20 from an inner space of a washing tub 30 for the purposes of easily removing foreign materials, such as slime, etc., accumulated on the inner wall of the water tank 20 and also to visually check whether or not the foreign materials are removed as part of a cleaning process.

To this end, the washing machine according to an embodiment of the present invention may include a casing part 10, the water tank 20, the washing tub 30, a discharge member 40, a filter guide member 50, and a driving means 60.

Referring to FIG. 1, the casing part 10, or case, constitutes an entire outer periphery surface or wall of the washing machine, and for example, is of a hexahedral shape in one embodiment and is operable to protect and cover components disposed therein.

The water tank 20 stores washing water and has the washing tub 30, which will be described later, positioned in a space defined by an inner wall of the water tank.

The washing tub 30 is configured to receive washing items and to store them therein and may be rotated clockwise or counter-clockwise by rotational force generated by the driving means 60 which may be connected to a lower part of the washing tub. For example, the washing tub 30 is preferably configured to have a cylindrical shape and is also open at an upper side thereof, but there are no limitations regarding its shape. In addition, the washing tub 30 may include the first observing element 310 and a through hole 330.

Referring to FIG. 1, the driving means 60 is positioned on one side of the washing tub 30, and preferably, is positioned on the lower part of the washing tub 30, and is configured to generate the rotational force of the washing tub 30. For example, the driving means 80 may be a motor, and there is no limit thereto.

Referring to FIGS. 3 and 5, it is appreciated that the first observing element 310 allows the washing tub 30 to communicate with the water tank 20 when an inner wall of the washing tub 30 (with which the discharge member 40 is combined) is opened. Accordingly, when the discharge member 40, which can be coupled to, or decoupled from, the inner wall of the washing tub, is removed therefrom, a user can observe an inner wall of the water tank 20 from the inner space of the washing tub 30 (see FIG. 8). Furthermore, when the first observing element 310 is open, the shape of the first observing element 310 is preferably complementary to a shape of the rear surface of the discharge member 40. For example, when the first observing element 310 is open, the first observing element 310 may have a rectangular shape. Therefore, when the discharge member 40 is removed from the washing tub 30, the inner wall of the water tank 20 can be observed via the observing element. Accordingly, when cleaning the water tank 20 to remove foreign materials, the there is no need to disassemble the washing tub 30 from the water tank 20, and it is possible using the observing element to check visibly whether the inner wall of the water tank 20 is completely cleaned.

In addition, the washing tub 30 may include one first observing element 310 provided on the inner wall thereof, and preferably, may include a pair of first observing elements 310 provided on opposing sides of the inner wall of the washing tub 30. There is no limit in the number of first observing elements employed within embodiments of the present invention.

The first observing element 310 is configured to allow a user to observe the inner wall of the water tank 20, and the first observing element preferably has a sufficient size for easy observation. For example, a space interval between inner walls of lateral opposite sides of the first observing element 310, that is, a horizontal length therebetween is preferably configured to be roughly 50 mm to 90 mm and more preferably roughly 60 mm to 70 mm. In addition, a space interval between the inner walls of vertical opposite sides of the first observing element 310, that is, a vertical length therebetween is preferably configured to be roughly 500 mm to 700 mm and more preferably roughly 650 mm to 670 mm.

Generally, since the washing tub 30 is rotatably arranged, when the horizontal length of the first observing element 310 is maintained at a predetermined length or more (although the horizontal length thereof may be relatively narrow as in the above example), there is no difficulty for user observation. However, when the horizontal length is excessively narrow, user visibility is substantially prevented, thus the horizontal length is preferably configured to be 50 mm or more. Furthermore, when the horizontal length is configured to be more than 70 mm, a vertical length of the discharge member 40 that covers the first observing element 310 also becomes longer, which rapidly decreases the flow velocity of washing water which flows upward after being introduced into the discharge member 40 through a lower flow path of an inner side thereof. Accordingly, the efficient supply of the washing water into the inner space of the washing tub 30 is restricted and finally the efficient circulation of the washing water is also restricted.

Furthermore, the vertical length of the first observing element 310 is configured to be sufficiently long, but when the vertical length of the first observing element is more than 700 mm, it may be difficult to secure the vertical length of the discharge member 40, which is required to be longer than the vertical length of the first observing element 310. That is, washing water may not reach a discharge opening 40a on an upper side of a water supply member 410, which will be described later.

In addition, washing water, which flows over an upper side of a second flow path “b” of the frame member 430 and turns at 180 degrees and flows to a first flow path “a,” may be prevented from flowing over the upper side.

Furthermore, when the vertical length of the first observing element 310 is configured to be less than 500 mm, the inner wall of the washing tub 30 prevents user observation, which makes it difficult to achieve the objects of the present invention. However, the scope of the present invention is not limited to the above exemplary ranges.

Referring to FIG. 3, the through hole 330 is formed through the inner wall of the washing tub 30 adjacent to the first observing element 310 and receives a coupling pin 411, which will be described later, to be inserted thereinto. Accordingly, the filter guide member 50, which will be described later, can be securely fixed on the inner wall of the washing tub 30. The through hole 330 has roughly a rectangular shape and may be provided in plural, but the scope of the present invention is not limited thereto.

Referring to FIGS. 3 and 5, the discharge member 40 includes at least one discharge opening 40a provided on a front surface thereof and supplies circulating washing water to the inner space of the washing tub 30. At least one discharge member 40 may be provided on the inner wall of the washing tub 30. In addition, the discharge member 40 may include the water supply member 410 and the frame member 430, wherein the water supply member 410 is arranged directly on the inner wall of the washing tub 30. The frame member 430 is arranged in an inner groove of the filter guide member 50 by being inserted thereinto, which will be described later. Each of the water supply member 410 and the frame member 430 is arranged on a position corresponding to the first observing element 310 to cover an open space defined by the first observing element 310.

Furthermore, the discharge member 40 is configured and sized to completely cover the first observing element 310 in area in such a manner that the discharge member 40 can open the first observing element 310 and is preferably configured to be larger than the first observing element 310. Accordingly, the vertical length and the horizontal length of the discharge member are configured to be longer than the vertical length and the horizontal length of the first observing element 310.

Referring to FIGS. 2 and 3, the water supply member 410 is configured to supply washing water circulating through a flow path therein via discharge openings 40a to the inner space of the washing tub 30 and is also operable to be coupled to or decoupled from the washing tub 30.

In addition, the water supply member 410 includes the coupling pin 411 provided on a rear surface thereof by protruding therefrom, wherein the coupling pin 411 is inserted into the through hole 330, and comes into contact with (and is fixed to) a lower surface of the through hole 330. For example, the coupling pin 411 is extended in a horizontal direction from the rear surface of the water supply member 410, is bent downward and extended, and thus is preferably configured to have an overall L shape. At least one coupling pin 411 is provided on the rear surface of the water supply member 410. Accordingly, when the water supply member 410 is removed from the washing tub 30, the first observing element 310 is opened and thus the inner wall of the water tank 20 can be observed. Therefore, it is possible to perform efficient cleaning of the inner wall of the water tank 20.

Furthermore, preferably, for maintaining a secure connection of the water supply member 410 with the washing tub, the water supply member 410 is further combined with one side of the washing tub 30 by using any well known and suitable combining means, such as screws and/or fasteners.

Referring to FIGS. 4 and 5, the frame member 430 is arranged in the inner groove of the filter guide member 50 by being inserted thereinto, which will be described later, and supplies washing water to the inner space of the washing tub 30. More preferably, after foreign materials in the supplied washing water are removed, the filtered washing water is discharged to the inner space of the washing tub 30. Particularly, washing water flowing to the first flow path a defined by the combination of a case member 431 with a flow path forming member 435 is supplied via the discharge openings 40a on a front surface of the case member 431 to the inner space of the washing tub 30.

The frame member 430 may include the case member 431, a filter part 433, and the flow path forming member 435.

Referring to FIG. 6, the case member 431 constitutes a front surface of the frame member 430 to supply supplied washing water to an inner space of the washing tub 30, and includes the discharge opening 40a provided on a front surface of the case member, and more preferably, includes multiple discharge openings 40a.

In addition, referring to FIG. 7, the case member 431 includes a combining part 431a provided on an upper surface thereof.

The combining part 431a is provided on the upper surface of the frame member 430 and the thickness of the combining part can be flexibly changed or manipulated, which promotes secure combination with (or the efficient removal of) the frame member 430 from the filter guide member 50, which will be described later. To this end, the combining part 431a may include a bent part 431a-1 and a protruding part 431a-2.

The bent part 431a-1 is disposed on the upper surface of the case member 431 and is extended in a predetermined length to the rear surface of the case member 431 from the front surface thereof and is again extended with a bend upward and then is again extended in a predetermined length to the front surface of the case member 431 from the rear surface thereof, and accordingly is configured to have a U shape generally.

The protruding part 431a-2 extends from one end of the bent part 431a-1, and more particularly, is configured to be extended to an upper side of the case member 431 from an upper end of the bent part 431a-1.

Accordingly, the upper surface of the bent part 431a-1 is in contact with a combining step 530 of the filter guide member 50 without space between such that the case member 431 or the frame member 430 is securely connected with the filter guide member 50. On the contrary, when the protruding part 431a-2 is pressed in a direction contrary to a protruding direction of the protruding part, the entire thickness of the combining part 431a (which can be changed) is decreased relatively and accordingly, then an interval develops between the combining part 431a and the combining step 530. In this case, the case member 431 or the frame member 430 can be easily removed from the filter guide member 50.

Referring to FIGS. 6 and 7, the filter part 433 is arranged on the discharge openings 40a of the frame member 430. That is, the filter part 433 is arranged on the rear surface of the case member 431 and is configured to have a mesh structure to filter foreign materials included in washing water. Generally, washing water circulating during washing is introduced to the second flow path b defined by the flow path forming member 435 and the filter guide member 50 being spaced apart from each other. Washing water flowing upward through the second flow path b flows to a communication space of an upper side of the first flow path “a” by an induction member (not shown). In this case, the washing water introduced to the first flow path “a” includes foreign materials but the filter part 433 collects the foreign materials and the filtered washing water is supplied via the discharge openings 40a to the inner space of the washing tub 30.

The flow path forming member 435 is combined on a rear side of the case member 431, and the flow path forming member has the first flow path “a” defined in cooperation with the rear surface of the case member 431. In addition, height of the flow path forming member 435 is preferably configured to be lower than height of the case member 431 such that washing water flows over the upper side of the second flow path “b” and is introduced to the upper side of the first flow path “a”.

In addition, a lower side of the flow path forming member 435 is preferably hinged to a lower side of the case member 431. Accordingly, an upper side of the flow path forming member 435 is rotated to be decoupled from the case member 431, which enables removal of foreign materials collected by the filter part 433.

Referring to FIG. 5, the filter guide member 50 is arranged on the inner wall of the washing tub 30, and is configured to allow the case member 431, or the frame member 430, to be inserted into and held in a recessed space provided on one side of the filter guide member. To this end, the filter guide member 50 may include a recessed part 510, the combining step 530, and the coupling plate 550. In addition, the filter guide member 50 is preferably positioned adjacent to edges of the first observing element 310 or to cover a part thereof. The filter guide member 50 is positioned on the inner wall of the washing tub 30 and is preferably configured to be integral to the washing tub 30. However, the scope of the present invention is not limited thereto.

The recessed part 510 is recessed in a predetermined depth from a front surface thereof to a rear surface thereof such that the case member 431 or the frame member 430 is inserted into the recessed part. The recessed shape of the recessed part preferably has a shape complementary to a shape of the case member 431 or the frame member 430.

Furthermore, when the filter part 433 and the coupling plate 550 are removed from the filter guide member 50, the first observing element 310 is open through the recessed part 510. The first observing element 310 (open through the recessed part 510) is configured to be covered by the coupling plate 550. The recessed part 510 is also preferably configured to be larger than the coupling plate 550 such that the coupling plate 550 is easily inserted into and fixed to the inner side of the recessed part 510. Accordingly, the recessed part 510 is larger in height and width than the first observing element 310.

For example, the space interval between inner walls of opposite sides of the recessed part 510, that is, the horizontal length therebetween, is configured to be longer than the horizontal length of the first observing element 310, and for example, is preferably configured to be around 80 mm to 100 mm. In a case that the horizontal length of the recessed part 510 is less than 80 mm, interference with the coupling plate 550 may occur when the coupling plate 550 is inserted to the inner side of the recessed part 510, which decreases usability. However, when the horizontal length of the recessed part 510 is more than 100 mm, the flow velocity of washing water, which flows upward after being introduced into the lower side of the second flow path “b” of the frame member 430, may decrease rapidly.

In addition, the distance between the inner walls of vertical sides of the recessed part 510, that is, the vertical length therebetween is also configured to be longer than the vertical length of the first observing element 310, and for example, is preferably configured to be around 700 mm to 800 mm. When the vertical length is less than 700 mm, the coupling plate 550 is interfered by the recessed part 510, and when the vertical length is more than 800 mm, washing water is prevented from flowing over the upper side of the second flow path “b”.

The combining step 530 is positioned on an upper side of the recessed part 510 by protruding therefrom to a center of the washing tub in a horizontal direction, and a lower surface of the combining step 530 contacts with the upper surface of the bent part 431a-1, and a front surface of the combining step 530 contacts with the protruding part 431a-2. Accordingly, the bent part 431a-1 is in surface contact with the combining step 530 without a space interval such that the case member 431 or the frame member 430 is securely fixed in the inner space of the recessed part 510. In addition, as mentioned above, the bent part 431a-1 is contracted by pressing the protruding part 431a-2 in a direction opposite to a protruding direction of the protruding part such that the case member 431 or the frame member 430 is easily removed from the recessed part 510 (see FIG. 7).

The coupling plate 550 constitutes a part of a rear surface of the filter guide member 50 and is configured to be removably connected with the filter guide member 50. Accordingly, when the coupling plate 550 is removed, the first observing element 310 is open on the rear surface of the filter guide member 50, and thus it is possible to advantageously easily remove foreign materials on the inner wall of the water tank 20 and to check visibly whether the foreign materials are completely removed after cleaning.

As mentioned above, the coupling plate 550 is configured to cover the open space of the first observing element 310, and a body part of the coupling plate 550 except for a first and second combination pin 551, 553, which will be described later, and is configured to be complementary to the first observing element 310. Preferably, the size of the coupling plate 550 is also configured to be the same size as the first observing element 310. When the coupling plate 550 (configured to be longer than the first observing element 310 in vertical and horizontal lengths) covers the first observing element 310, one side of the coupling plate 550 or opposite ends thereof form a step in cooperation with the washing tub 30, which may prevent a flow path from being defined on the inner side of the frame member 430.

That is, the width of the second flow path “b” defined on the inner side of the frame member 430 is not regular, and a space interval between the coupling plate 550 and the inner wall of the washing tub 30 occurs, whereby washing water leak may occur in the second flow path “b”.

To solve this problem, the coupling plate 550 may include a first combination pin 551 and the second combination pin 553.

The first combination pin 551 is provided on an upper surface of the coupling plate 550 and is inserted into an insertion hole (not shown) formed on the inner wall of the washing tub 30 such that the upper side of the coupling plate 550 is fixed on the inner wall of the washing tub 30 on a side of the rear surface of the filter guide member 50. For example, the first combination pin 551 is extended upward from an upper end of the coupling plate, is bent and extended in a horizontal direction, and is extended downward, and accordingly, may be configured to have a U shape generally, but is not limited to this configuration. As shown in the drawings, a pair of first combination pins 551, being spaced apart from each other, may be provided on the upper surface of the coupling plate 550, and the first combination pins 551 may be provided on a center side of the coupling plate 550, but there is no limit thereto.

The second combination pin 553 is provided on a lower surface of the coupling plate 550 and is inserted into the insertion hole formed on the inner wall of the washing tub 30 such that the lower side of the coupling plate 550 is fixed on the inner wall of the washing tub 30 on the side of the rear surface of the filter guide member 50. For example, the second combination pin 553 is extended downward from a lower end of the coupling plate, is bent and extended in a horizontal direction, and is extended upward, and accordingly, may be configured to have a general U shape on the whole, but is not limited to this configuration. The number of the second combination pin 553 has no limitation as the number of the first combination pin 551 and may be changed.

Accordingly, when the coupling plate 550 is decoupled from the recessed part 510 of the filter guide member 50, as mentioned above, the first observing element 310 is accessible and thus when cleaning the inner wall of the water tank 20, the washing machine does not need to be disassembled, thereby eliminating inconvenience caused by disassembly and also decreasing cleaning costs due to the disassembly. Furthermore, the inner wall of the water tank 20 can be easily observed in this configuration, and thus a user can readily and advantageously determine whether the inner wall of the water tank 20 is completely cleaned.

The detailed description above illustrates the present invention. In addition, the above-mentioned details are described according to the exemplary embodiments of the present invention, and the present invention may be used in various combinations, modifications, and environments. Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A washing machine comprising:
a casing constituting an overall exterior and protecting components therein;
a water tank operable to store washing water;
a washing tub positioned in a space defined by an inner wall of the water tank, wherein the washing tub is operable to store washing items therein and to rotate by a driving means coupled to a side of the washing tub;
at least one discharge member comprising at least one discharge opening disposed on a front surface thereof and operable to discharge circulating washing water to an inner space of the washing tub; and
a first observing element disposed on the washing tub, the first observing element operable to allow the washing tub to communicate with the water tank when an inner wall of the washing tub is opened, wherein the inner wall of the washing tub is connected to the discharge member.

2. The washing machine of claim 1, wherein the discharge member is removably connected to the inner wall of the washing tub, and the first observing element has a shape complementary to a shape of a rear surface of the discharge member.

3. The washing machine of claim 1, wherein the discharge member is operable to supply washing water circulating through a flow path thereof via the discharge opening disposed on the front surface of the discharge member to the inner space of the washing tub and wherein the discharge member also comprises a water supply member operable to cover the first observing element disposed on the washing tub.

4. The washing machine of claim 3, wherein the washing tub comprises through holes disposed on sides neighboring the first observing element, wherein the through holes are formed through the inner wall of the washing tub, and
wherein the water supply member comprises coupling pins disposed on a rear surface thereof and protruding therefrom, wherein the coupling pins extend in horizontal directions from the rear surface of the water supply member and further extend bent downward for insertion into and connection with the through holes.

5. The washing machine of claim 1, further comprising a recessed part disposed on one side thereof, the recessed part recessed at a predetermined depth from a front surface thereof to a rear surface thereof and further comprises a filter guide member positioned adjacent to edges of the first observing element, and
wherein the discharge member is inserted into an inner space of the recessed part and includes a frame member operable to discharge circulating washing water to the inner space of the washing tub.

6. The washing machine of claim 5, wherein the filter guide member further comprises a coupling plate disposed on a rear surface thereof, the coupling plate being removably connected with the rear surface of the filter guide member to cover the first observing element.

7. The washing machine of claim 6, wherein the coupling plate comprises a first combination pin disposed on an upper surface thereof wherein the first combination pin fixes an upper side of the coupling plate to the inner wall of the washing tub by being inserted into an insertion hole provided on the inner wall of the washing tub.

8. The washing machine of claim 5, wherein the frame member comprises:
a case member disposed on a front surface thereof, the case member operable to supply washing water via the discharge opening provided on one side of the case member to an inner space of the washing tub;
a filter part of a mesh structure disposed on a rear surface of the case member and operable to filter foreign materials included in the washing water; and
a flow path forming member connected to a rear side of the case member, the flow path forming member having a first flow path defined in cooperation with the inner wall of the case member and having a second flow path defined by a space between the filter guide member.

9. The washing machine of claim 8, wherein a height of the flow path forming member is less than a height of the case member.

10. The washing machine of claim 8, wherein the filter guide member further comprises a combining step disposed on an upper side of the recessed part and protruding therefrom to a center of the washing tub in a horizontal direction, and
wherein the case member comprises a combining part disposed on an upper surface thereof, the combining part flexibly varying in thickness to be in close contact with the combining step, and wherein further,
the combining part comprises a bent part having a U shape and disposed on the upper surface of the case member, the bent part being pressed in an upper side thereof by a lower surface of the combining step, and a protruding part being in contact with a front surface of the combining step by extending from the upper side of the bent part in a protruding direction of the protruding part.

11. The washing machine of claim 1, wherein the first observing element is configured to be within a range of 50 mm to 90 mm in horizontal length and within a range of 500 mm to 700 mm in vertical length, and wherein further,
the discharge member is longer than the first observing element corresponding thereto in vertical length and horizontal length to cover the first observing element wherein the first observing element can be selectively covered and uncovered.

12. The washing machine of claim 5, wherein the recessed part is longer than the first observing element in vertical length and horizontal length, and wherein
the first observing element is within a range of 50 mm to 90 mm in horizontal length and within a range of 500 mm to 700 mm in vertical length, and wherein further the recessed part is configured to be within a range of 80 mm to 100 mm in horizontal length and within a range of 700 mm to 800 mm in vertical length.

13. The washing machine of claim 6, wherein the coupling plate has a shape complementary to a shape of the first observing element and is configured to have a same size as a size of the first observing element.

14. A washing machine comprising:
an outer casing operable to protect components therein;
a water tank operable to store washing water;
a washing tub positioned in a space defined by an inner wall of the water tank, wherein the washing tub is operable to have washing items stored therein and operable to be rotated by a driving means connected to a lower part of the washing tub;
a frame member disposed in an inner space of a filter guide by being inserted thereinto and operable to discharge circulating washing water via discharge openings provided on one side of the frame member to an inner space of the washing tub; and
a filter guide member disposed on one side of an inner wall of the washing tub, the filter guide member comprising a recessed part recessed at a predetermined depth from a front surface thereof to a rear surface thereof and being open on a part of a rear surface thereof, and
wherein the washing tub comprises a first observing element provided thereon, the first observing element allowing the washing tub to communicate with the water tank when an inner wall of the washing tub, with which a case member is connected, is opened.

15. The washing machine of claim 14, wherein the filter guide member comprises a coupling plate disposed on an open rear surface of the filter guide member, the coupling plate being removably connected with the filter guide member and is operable to cover the first observing element.

16. The washing machine of claim 15, wherein the coupling plate comprises a first combination pin and a second combination pin disposed on an upper surface thereof and a lower surface thereof, respectively, wherein the first combination pin and the second combination pin fix an upper side of the coupling plate and a lower side thereof, respectively, to the inner wall of the washing tub and are inserted into insertion holes provided on the inner wall of the washing tub.

17. The washing machine of claim 14, wherein the filter guide member is arranged adjacent to edges of the first observing element or arranged to cover a part of the first observing element.

18. The washing machine of claim 15, wherein the frame member comprises a filter part arranged on the discharge openings of the case member to filter any foreign materials in the washing water.

19. The washing machine of claim 15, wherein the frame member further comprises a flow path forming member connected on a rear side of the case member at a rear side of the filter part, wherein the flow path forming member having a first flow path defined in cooperation with the inner wall of the case member and the flow path forming member having a second flow path defined by a space between the filter guide member.

20. The washing machine of claim 15, further comprising:
the case member, wherein the case member is disposed at a position corresponding to a position of a second observing element disposed on the water tank and operable to cover an open space defined by the second observing element, wherein the case member includes the discharge openings provided on a front surface thereof to supply circulating washing water to the inner space of the washing tub.
